(19) United States
(12) Patent Application Publication
(10) Pub. No.: US 2014/0114911 A1
(43) Pub. Date: Apr. 24, 2014

(54) COOPERATION SYSTEM USING OPEN PUBLIC NETWORK

(71) Applicants: Hon Zong Choi, Gangnam-gu (KR); Seok Woo Lee, Seongnam-si (KR); Young Jae Choi, Gwangjin-gu (KR); Sung Ho Nam, Yeonsu-gu (KR)

(72) Inventors: Hon Zong Choi, Gangnam-gu (KR); Seok Woo Lee, Seongnam-si (KR); Young Jae Choi, Gwangjin-gu (KR); Sung Ho Nam, Yeonsu-gu (KR)

(73) Assignee: KOREA INSTITUTE OF INDUSTRIAL TECHNOLOGY, Cheonan-si, Chuncheongnam-do (KR)

(21) Appl. No.: 13/695,054

(22) PCT Filed: Oct. 23, 2012
(86) PCT No.: PCT/KR12/08727

§ 371 Date: Oct. 29, 2012

(51) Int. Cl. G06F 17/30

(52) U.S. Cl. CPC G06F 17/30011; H04L 65/403
USPC 707/608; 709/204; 707/783; 715/810

(57) ABSTRACT

There is disclosed a collaboration system using an open public network for providing collaboration services among a plurality of enterprises including a server configured to implement a plurality of processes for the collaboration services; a user terminal connecting to the server via the open public network to restrictedly uses data generated by the processes according to a user permission; and a database configured to store the data generated by the processes, wherein the server implements the processes comprising a project development process, a data change process, a general business process and a collaboration process, and the server restrictedly messages an event generated during the implementation of the processes to the user terminal according to the user permission.

### TECHNICAL FIELD

The present invention relates to network-based collaboration, more particularly, to a collaborative system that supports development and general business processes in an enterprise and development, collaboration and business interchange among enterprises via a open public network.

### BACKGROUND ART

Industrial development has been led by particular industries such as IT, semiconductor, shipbuilding, car industries and manufacturing have been the driving force behind economic growth and export.

In spite of such industrial development, small and medium-sized enterprises have weak technology foundation and lack of a new product development ability. Also, high-quality resources are increasingly avoiding manufacturing industries, even with the rise in personnel expenses. Accordingly, the international competitiveness has been weak.

Moreover, with recent Fast economic growth in China, the competition with China has been intensified and domestic industries failing to have price competitiveness move into China increasingly and fears over hollowness are near boiling point. Accordingly, now it is time for quality differentiation enabled by business process innovation.

Recently, there are moves to retrieve the limitation of the price competitiveness in the manufacturing industries through product innovation such as new product development based on R&D. such the limitation is generated from an industrial type that invests human resources and equipments massively before 1990's to seek to build up a global competitiveness.

However, insufficient process innovation makes it difficult to secure such global price competitiveness and insufficient collaboration between major companies and supply sources. Results in weak competitiveness to deal with new products. The manufacturing industries are faced with a time of new transition to survive the rapidly changing global market circumstances and keen competition.

To deal with various demands of the user-centric market, the manufacturing industries have to perform introduction and application of new technologies to reduce the price and be flexible in responding to shortened life-cycles of products.

The paradigm of the past mass-production type manufacturing requires the manufacturing industries to enable reflection of rapid market demand conditions, rapid payment term and manufacturing of high-quality products.

In the past manufacturing paradigm, major companies are wholly responsible for product development and production processes and they perform a collaborative process with small and medium-sized enterprises only in simply business processes such as simple tall processing, mold fabrication or part assembling.

However, such the past business relation cannot perform high income and fast growth.

Accordingly, major companies are responsible for marketing, product planning, product development that are core technologies and the small and medium-sized enterprises are responsible for the production function including advanced development, module development and product/parts production processes, which the major companies have been responsible for, only to enable a new structure of technological collaboration. For that, the essential part is expansion of collaboration infrastructure for business-to-business technology and quality collaboration.

For recent several years, collaboration infrastructure restoration businesses (for example, E-manufacturing business) have been promoting in connection with private enterprises.

Through such collaboration infrastructure businesses are successfully restored injection mold design collaboration hub systems, injection mold production collaboration hub systems, blow product collaboration hub systems and engineering collaboration systems. Accordingly, such collaboration has been applied to activation and advancement of collaboration infrastructure-based business using the internet and expansion of company subject thereto.

The supports of the collaboration infrastructure business has been expanded from injection mold collaboration system, which is an industrial technology infrastructure, to the support for various groups of industries such as reinforcement of established-system function, a design that is a prior process of business processes and auto-mold collaboration that is the root for supporting the development process.

The collaboration infrastructure business is one of examples built by deriving various business-to-business collaboration business models based on the internet and analyzing major company to middle-sized company collaboration, middle-sized company collaboration and middle-sized company to small-sized company collaboration process.

Such the collaboration infrastructure business has the time of expansion and dissemination to the same or similar business, with an urgent problem of area, business category and industrial spread.

As a result, there have been increasing demands on a web-based collaboration infrastructure system for manufacturing business to manufacturing business that can be utilized regardless of industrial types, passing the limits of manufacturing business. In other words, to induce participation of more companies, expanded application of the collaboration infrastructures to various products and business areas.

Measures to solve uneven regional development as well as the application products of the collaboration infrastructure and expansion of business categories are urgently needed. To promote specialized industries in specific areas and balanced development between regions, technological competitiveness reinforcement of local enterprises is promoted through connection with regional clusters and regional expansion of collaboration infrastructures. Moreover, improvement of domestic manufacturing industries is required by activation of nationwide collaboration infrastructure performed through connection of a collaboration infrastructure built between the capital area and the local areas.

### DISCLOSURE

### Technical Problem

Accordingly, the present invention may be directed to a collaboration system using an open public network. To solve the problems, an object of the present invention may be to provide a collaboration system using an open public network which is able to support improvement of industrial structure for various manufacturing enterprises requiring payment reduction, cost reduction and quality improvement in collaboration among enterprises, regardless of business types.

Another object of the present invention may be to provide a collaboration system using an open public network which is able to provide integrated work circumstances for project development management, design change and inconsistence management, providing of various applications to check a CAD or word file, electronic payment and a messaging service.

A further object of the present invention may be to provide a collaboration system using an open public network which is able to systematically manage an on-going project on a web, to stores all of project products for each project such as documents or drawings to make easy to search, to manage business progress and change history for the project, to message changed contents when drawings or documents are changed via a messaging service, to manage the change history of business documents via version management, to ask for quality information on generation, examination and processing of the design change and inadequate quality generated in a design process for each project in real time.

A still further object of the present invention may be to provide a collaboration system using an open public network which is able to make business progress report shared with clients in real time and to enable opinion exchange and material exchange via an on-line meeting service.

### Technical Solution

To achieve these objects and other advantages and in accordance with the purpose of the present invention, as embodied and broadly described herein, a collaboration system using an open public network for providing collaboration services among a plurality of enterprise includes a server configured to implement a plurality of processes for the collaboration services; a user terminal connecting to the server via the open public network to restrictedly uses data generated by the processes according to a user permission; and a database configured to store the data generated by the processes, wherein the server implements the processes comprising a project development process, a data change process, a general business process and a collaboration process, and the server restrictedly messages an event generated during the implementation of the processes to the user terminal according to the user permission.

### Advantageous Effects

The present invention have following advantageous effects. According to the present invention, the system is operated based on a web and collaboration business is possible for prior development, module development or products/parts production anywhere and domestic regions only if connectible to the internet. Also, data associated with the collaboration can be searched and shared anytime and anywhere only if the internet is connectable.

The project design and products in a product manufacturing process are shared with a client in real time. Accordingly, business accuracy and transparency can be secured.

The client can monitor a progress report of an ordered product in real time. Accordingly, reliability can be enhanced.

Multilingual services (Korean, English and Japanese) are provided and the multilingual services can be utilized in collaboration with overseas clients.

Contents of an on-line meeting progressed via the on-line meeting service may be automatically stored and auxiliary minutes may not be required. The moving time and money taken to participate an actual meeting can be saved.

In case a situation requiring business action happens, texture messaging is provided via the messaging service to enable rapid and accurate communication. Also, the dedicated electronic mail service for business is provided.

The various applications (CAD viewer, word file viewer and etc.) required in checking products of the design and fabrication of the goods may be provided. Accordingly, auxiliary applications do not have to be purchased. Also, design data created via CAD can be asked for and checked with one click.

The document using as business form currently can be included in an electronic payment document as it is. Accordingly, usage can be convenient and payment can be possible anywhere and anytime on a business trip or an outside work. It is to be understood that both the foregoing general description and the following detailed description of the embodiments or arrangements are exemplary and explanatory and are intended to provide further explanation of the embodiments as claimed.

### DESCRIPTION OF DRAWINGS

FIG. 1 is a diagram illustrating an entire configuration of a collaboration system using an open public network according to the present invention;

FIG. 2 is a diagram illustrating a configuration of a server provided in the collaboration system using the open public network according to the present invention;

FIG. 3 is a diagram illustrating a detailed functional configuration of the server provided in the collaboration system using the open public network according to the present invention;

FIG. 4 is a diagram illustrating a development business process performed by a project development management unit according to the present invention;

FIG. 5 is a diagram illustrating a changed business process performed by a change management unit according to the present invention;

FIG. 6 is a diagram illustrating a general business process performed by an enterprise business management unit according to the present invention;

FIG. 7 is a diagram illustrating a collaboration process performed by a collaboration management unit according to the present invention;

FIG. 8 is a diagram illustrating an on-line meeting performed by an on-line meeting processing unit according to the present invention; and

FIG. 9 is a diagram illustrating a messaging process performed by a message processing unit according to the present invention.

### BEST MODE

Reference will now be made in detail to the specific embodiments of the present invention, examples of which are illustrated in the accompanying drawings. Wherever possible, the same reference numbers will be used throughout the drawings to refer to the same or like parts.

In a specific case, there may be terminology selected by the applicant of the present specification on his or her own discretion and meaning of corresponding terminology will be described in the detailed description. As a result, the terminologies used in the present specification has to be understood based on substantial meaning possessed thereby and contents of the specification, not based on simple titles of the terminologies.

Referring to the accompanying drawings, a collaboration system using an open public network according to an exemplary embodiment of the present invention will be described in detail as follows.

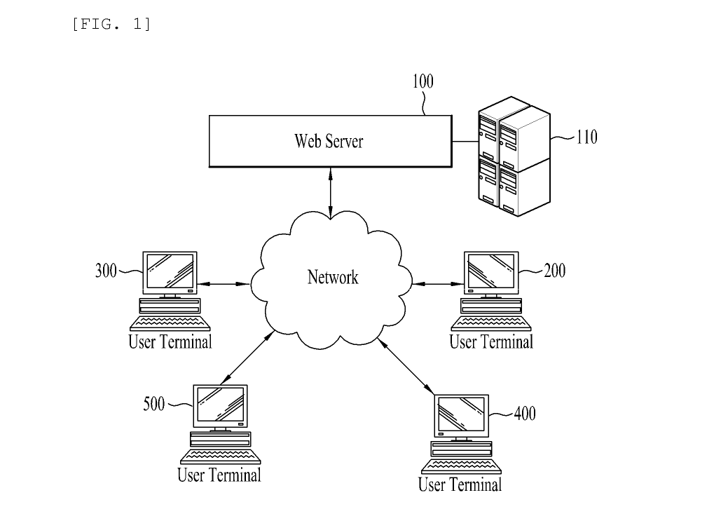

FIG. 1 is a diagram illustrating an overall configuration of a collaboration system using an open public network according to the present invention.

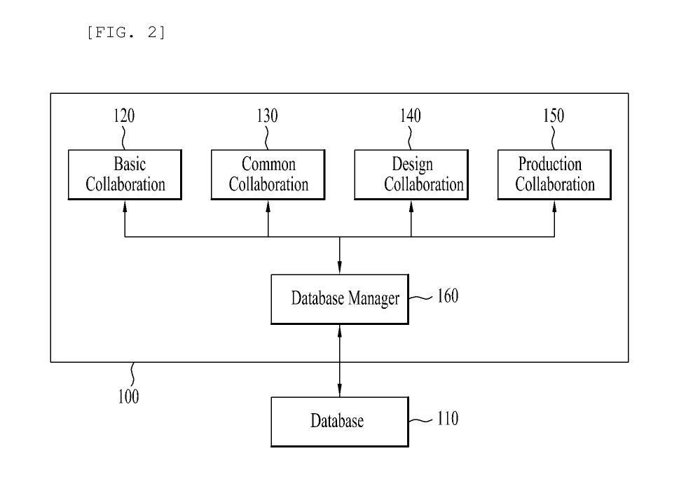

FIG. 2 is a diagram illustrating a configuration of a server provided in the collaboration system using the open public network according to the present invention.

Referring to FIGS. 1 and 2, the system according to the present invention realizes various services via network connection between a client and a server.

A collaboration system provided by a server 100 in the system according to the embodiment of the present invention generally includes a basic collaboration service, a common collaboration service, a design collaboration service and a production collaboration service.

Applications for supporting the collaboration services include a basic collaboration application 120, a common collaboration application 130, a design collaboration application 140 and a production collaboration application 150. The server 100 enters and stores data associated with events generated by implementation of the applications in a database 110.

Such the applications may support project development business, general business, collaboration and business interchange.

In the system providing such collaboration services and the applications for the collaboration services, clients are a plurality of enterprises (including cooperative enterprises, ordering enterprises and order-receiving enterprises) and user terminals 200, 300, 400 and 500 corresponding to working human resources in the enterprises. Enterprises or personnel in the enterprises that will be used in following description have to be understood as user terminals 200, 300, 400 and 500.

The applications for the collaboration services supported by the server 100 include a project development management function, a change management function, an enterprise business management function, a collaboration management function, an on-line meeting function and a messaging function.

The project development management function is a function configured to manage an on-going project on an open public network systematically and to manage collaborative businesses in other departments a cooperative enterprises.

The change management function is a function configured to categorize and store changed contents generated in projects and a history of changes for each project and to notice a change event to a registered worker in case a change event is generated.

The enterprise business management function is a function configured to manage a progress report of business in an enterprise and work products totally and to support electronic mains and manage sensing and receiving of electronic mails.

The collaboration management function is a function configured to enable managers of ordering and order-receiving enterprises to monitor a progress report of an ordered/order-received product in real time. The function for collaboration management is communication with a multi-national language supplyment function.

The on-line meeting function is a function configured to progress an on-line meeting that can be held anytime and anywhere in real time, with sharing data of drawings and document.

The messaging function is a function configured to message users that have permission for events generated in the functions, in communication with the project management function, the change management function, the enterprise business management function and the collaboration management function.

The server 100 provides an application configured to check files made or created in CAD or word processing program, rather than the applications for the collaboration services mentioned above. In other words, the server 100 provides an application that enables users to check CAD files and word files registered stored in the database 110 via a website.

Moreover, the server 100 progresses usage registration for users (the enterprises or personnel in the enterprises) connecting to the system via the user terminals 200, 300, 400 and 500 and provides permissions to users.

In the usage registration, an identifier (ID) and a personal code number for access to the server 100 are given to users. Usage permission is provided to each user that completed the usage registration. The usage permission restricts access to the applications or data and downloading and reading of the applications or data. Also, the usage permission restricts usage of the functions provided by each of the applications and usage of the data stored in the database 110. Especially, predetermined usage permissions corresponding to characteristics and businesses types of the enterprises may be provided and predetermined usage permissions are given, corresponding to personnel based on positions or work participation in each enterprise.

Accordingly, the present invention basically implements openness of applications and data. However, the present invention implements partial openness or restricted openness corresponding temporary openness based on the usage permission.

The system according to the present invention is to provide collaboration services between enterprises. For the collaboration services, the server 100 implements a project development process, a data change process, a general business process, a collaboration process, an on-line meeting process and a messaging process. The user terminals 200, 300, 400 and 500 connect to the server 100 via an open public network to restrictedly use data generated in the processes of the server 100 according to the user permissions. The database 110 registers and stores the data generated in the processes therein.

Especially, the server 100 according to the present invention restrictedly messages events generated during the implementation of the processes to the user terminals 200, 300, 400 and 500 according to the usage permissions.

The server 100 stores the data generated or changed during the implementation of the processes via the applications for the collaboration services in the database 110. At this time, the database 110 is controlled by a database manager 160.

When access to the data stored in the database 110 is generated, the database manager 160 checks user permission from registration information on an appropriate user and allows or restricts the access to corresponding data. In case of a user having the restricted access to the corresponding data, it is messaged to the corresponding user terminal that the access to the corresponding data is restricted.

The database manager 160 stores data generated or changed via the applications for the collaboration services in the database 110, and also it sequentially stores details of change history in case of the changed (or corrected) data.

As one of processing examples according to the usage permissions, a reading permission on design drawings and data created in a developing process of a specific product, a permission to correct (or change) the drawings and data, a permission to message new registration, reading or correcting (changing) of the design drawings and data may be restricted. When a user (an enterprise or an personnel in an enterprise) having a predetermined low rating implements an application for a development business, a function for correcting (changing) or a function for storing the result of implementation is restricted.

Usable ones of the applications are restricted according to the usage permission. Even in case of the usage applications, a usable menu is restricted in an appropriate one of the usable applications according to the usage permission. For example, a user having no permission to participate a project is not allowed to use the application associated with the project development management, which will be described later. When a user having no permission to correct (change) the design drawings implements the application for the project development management, a required menu for correcting (changing) is set as ‘UNAVAILABLE’.

As various usage permissions are given according to users' work characteristics, a structure of positively restricting usage of an application for project development business or general business or menu usage of each application may be applied to the present invention.

Accordingly, the server 100 in the system sets basic applications and basic menus of each application required by the project development business and general business process as ‘AVAILABLE’ for all of the user terminals 200, 300, 400 and 500. It sets additional applications and additional menus of each application as ‘AVAILABLE’ based on usage permissions given to users.

Next, each of functions provided via the applications for the collaboration services defined as mentioned above will be described in detail. The functions which will be described as follows can be operated as one independent application.

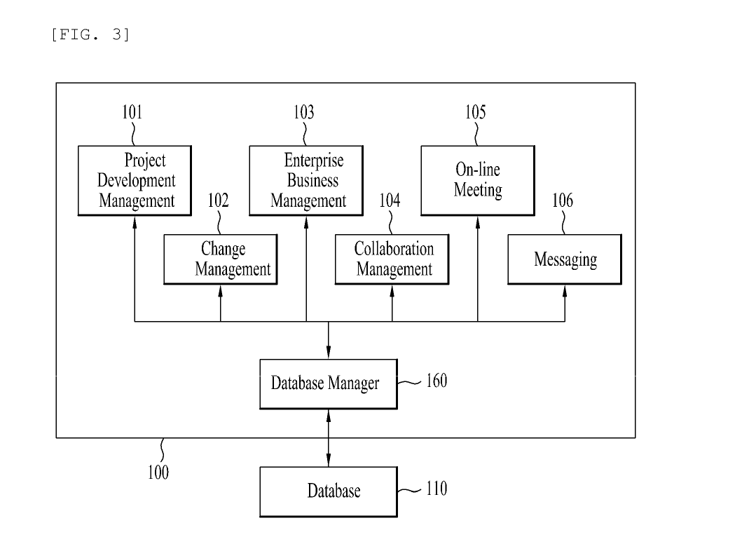

FIG. 3 is a diagram illustrating a detailed functional configuration of the server provided in the collaboration system using the open public network according to the present invention.

The server may include a project development management unit 101, a change management unit 102, an enterprise business management part 103, a collaboration management unit 104 and an on-line meeting processor unit 105. The server 100 may further include a messaging processor unit 106.

The project development management unit 101 systematically manages project development on an open public network and implements management of collaboration business between enterprises and collaboration business between departments in an enterprise.

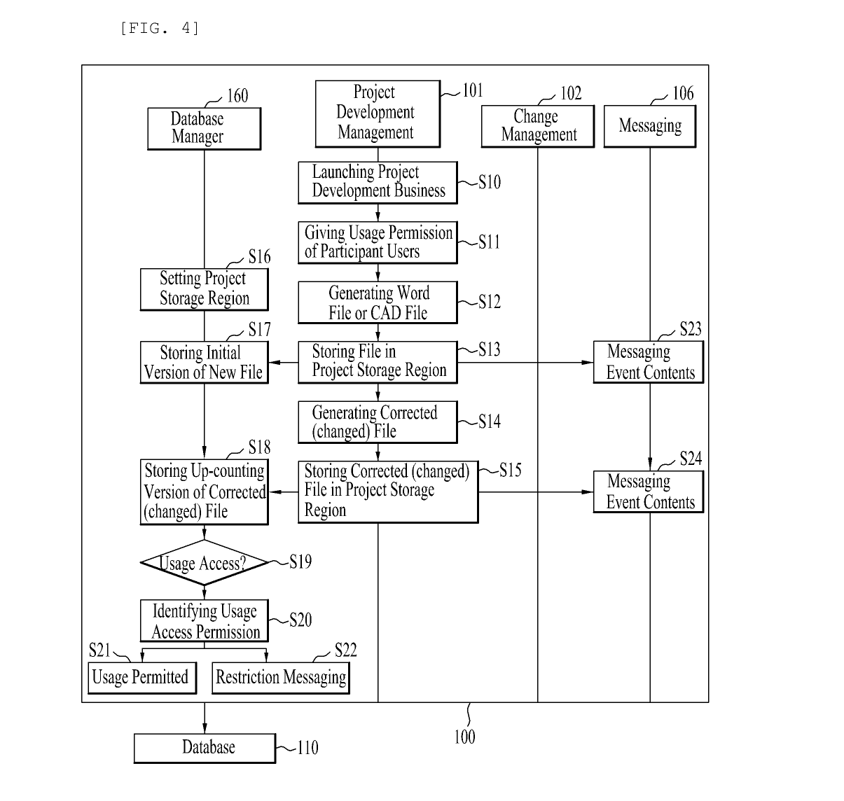

FIG. 4 is a diagram illustrating a development business process performed by a project development management unit according to the present invention.

Referring to FIG. 4, when a development business on a specific project is undertaken (S10), the project development management unit 101 gives a usage permission to users who participate a corresponding project (S11).

For example, the users may be given one of a second-rate permission on a project design, a third-rate permission on project design and correction (change) and a fourth-rate permission on project design, correction (change) and final decision. In this instance, a first user terminal 200 is given a second-rate permission and a third user terminal 300 is given a third-rate permission. A third user terminal is given a fourth-rate permission.

As another example, the project development management unit 101 may provide a word processing program and a design creating program that are necessary in the project design and correction (change). Such programs may be Hunminjeongeum or 2D/3D CAD programs.

When a word file or CAD file is created in the business processing program or design creating program (S12), the project development management unit 101 stores the created word file or CAD file in the database 110 in communication with the database manager 160 (S13). The created word file or CAD file may be an initially created version.

When a corrected (changed) word file or CAD file is created in the word processing or design creating program (S14), the project development management unit 101 stores the corrected (changed) word file or CAD file in the database 110 in communication with the database manager 160 (S15). In this instance, the corrected (changed) word file or CAD file may have an up-counting version.

The database manager 160 sets a storage region of a corresponding project based on project information (a project title, a project usage permission) provided by the project development management unit 101, before storing the business or CAD file transmitted from the project development management unit 101 (S16).

After that, the database manager 160 identifies whether the word or CAD file transferred from the project development management unit 101 is a file stored in the storage region for the corresponding project or a new file. Such identification may be performed by comparison between the transferred file and the file stored in the storage region of the project.

When the word or CAD file is a new file not stored in the project storage region, the database manager 160 sets version information of the corresponding file as an initial version to store the new file (S17). In contrast, when the word or CAD file is the file stored in the project storage region in a state of being corrected (changed), the database manager 160 stores the corresponding file after up-counting version information of the corresponding file (S18).

Meanwhile, when the user has usage permission to access to the word or CAD file stored in the database 110 (S19), the database manager 160 identifies whether the user is allowed to have the access based on identification information (ID and code number) (S20). For example, it is identified whether the user permission rating is higher than the second-rate.

When the user is allowed to use the word or CAD file based on the result of the identification, the database manager 160 allows the user terminal to read the corresponding word or CAD file or transfers the corresponding word or CAD file to the user terminal (S21). In contrast, when the user's usage of the word or CAD file is restricted, the database manager 160 based on the result of the identification, the database manger 160 messages to the user terminal that the access to the corresponding file is restricted (S22).

The project development management unit 101 stores data associated with various events on the on-going project in the database 110, in communication with the database manager 160. Especially, the database manager 160 the data associated with the various events in communication with attribute data of the corresponding project.

Meanwhile, the project development management unit 101 messages storing of the word or CAD file, whenever the word or CAD file is generated and stored, to at least one user terminal via the messaging processor unit 106.

In other words, when storing the word or CAD file initially created after launching the project development business, the project development management unit 101 transfers corresponding event contents to the messaging processor unit 106. Accordingly, the messaging processor unit 106 messages the contents of the transferred events (having the initial version of the word or CAD file stored therein) to the user terminal registered as messaging object of the corresponding project in advance (S23).

When storing the word or CAD file corrected (changed) in the project development business, the project development management unit 101 transfers corresponding event contents to the messaging processor unit 106. Accordingly, the messaging processor unit 106 messages the contents of the transferred events (having the corrected (changed) version of the word or CAD file stored therein) to the user terminal registered as messaging object of the corresponding project in advance (S24).

As one of examples, the messaging processor unit 106 may message an access path to the corresponding file to enable the user to read the registered and stored file or corrected (changed) and stored file in the terminal possessed by the user corresponding to the messaging object via a viewer.

The change management unit 102 categorizes corrected (changed) contents and history of correction (change) generated in the project for each project and stores the categorized contents and history in the database 110. While storing the contents and history, the change management unit 102 messages corresponding changed events to the user associated with the corresponding project.

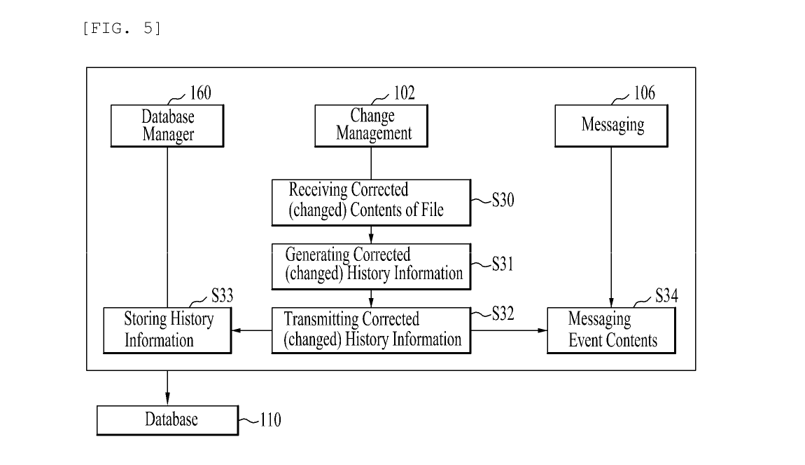

FIG. 5 is a diagram illustrating a changed business process performed by a change management unit according to the present invention.

Referring to FIG. 5, the change management unit 102 receives corrected (changed) contents of the corresponding file whenever the word or CAD file is corrected (changed) in the project development management unit 101 (S30).

When receiving the corrected (changed) contents of the file from the project development management unit 101, the change management unit 102 generates correction (change) history information (S31).

The change management unit 102 transfers event contents including the generated correction (change) history information and the corrected (changed) contents of the file to the messaging processor unit 106 (S32). At the same time, the change management unit 102 stores the generated correction (change) history information in the database 110, in communication with the database manager 160. The database manager 160 connects the correction (change) history information generated in the change management unit 102 to the file having the up-counting version information and it stores in the preset project storage region.

The messaging processor unit 106 messages the transferred event contents to the user terminal registered as the messaging object of the corresponding project in advance (S34).

The enterprise business management unit 103 categorizes products generated in the businesses of the enterprise for each business and stores the categorized data in the database 110. Also, the enterprise business management unit 103 stores history and progress report for each business in the database 110.

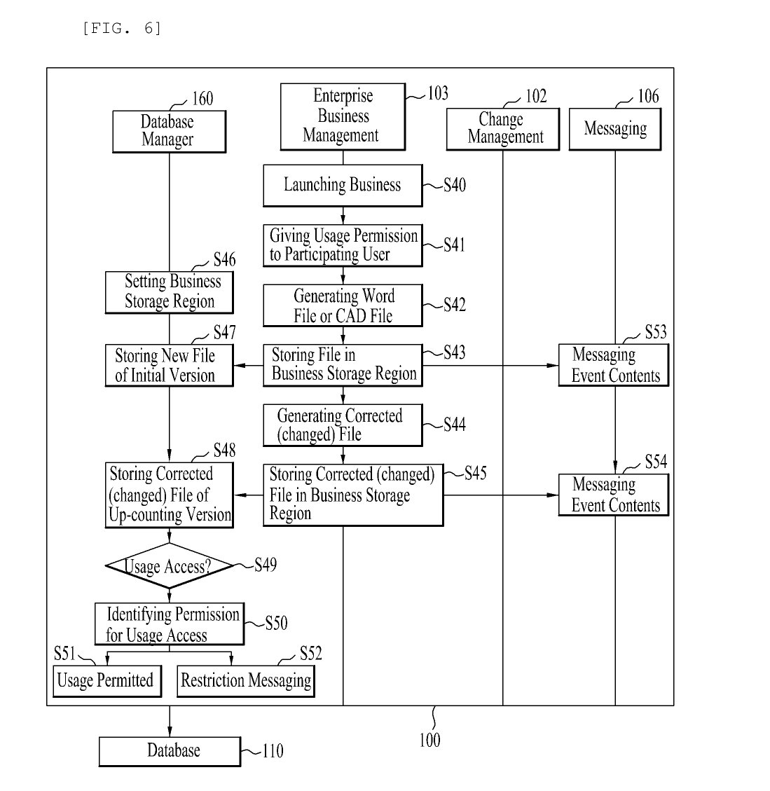

FIG. 6 is a diagram illustrating a general business process performed by the enterprises business management unit according to the present invention.

Referring to FIG. 6, when a specific business is launched in the enterprise (S40), the enterprise business management unit 103 gibes usage permissions to users who participates the corresponding business (S41).

As one example, For example, the users may be given one of a second-rate permission on a project design, a third-rate permission on project design and correction (change) and a fourth-rate permission on project design, correction (change) and final decision. In this instance, a first user terminal 200 is given a second-rate permission and a third user terminal 300 is given a third-rate permission. A third user terminal is given a fourth-rate permission.

As another example, the enterprise business management unit 103 may provide a word processing program and a design creating program that are necessary in the business performance and correction (change). Such programs may be Hunminjeongeum or 2D/3D CAD programs.

When a word file or CAD file is created in the word processing program or design creating program (S42), the enterprise business management unit 103 stores the created word file or CAD file in the database 110 in communication with the database manager 160 (S43). The created word file or CAD file may be an initially created version.

When a corrected (changed) word file or CAD file is created in the word processing or design creating program (S44), the enterprise business management unit 103 stores the corrected (changed) word file or CAD file in the database 110 in communication with the database manager 160 (S45). In this instance, the corrected (changed) word file or CAD file may have a version thereof up-counting.

The database manager 160 sets a storage region of a corresponding business based on business information (a business title, a business usage permission) provided by the enterprise business management unit 103, before storing the word or CAD file transmitted from the enterprise business management unit 103 (S46).

After that, the database manager 160 identifies whether the word or CAD file transferred from the enterprise business management unit 103 is a file stored in the storage region for the corresponding business or a new file. Such identification may be performed by comparison between the transferred file and the file stored in the storage region of the business.

When the word or CAD file is a new file not stored in the project storage region, the database manager 160 sets version information of the corresponding file as an initial version to store the new file (S47). In contrast, when the word or CAD file is the file stored in the project storage region in a state of being corrected (changed), the database manager 160 stores the corresponding file after counting up version information of the corresponding file (S48).

Meanwhile, when the user has usage permission to access to the word or CAD file stored in the database 110 (S49), the database manager 160 identifies whether the user is allowed to have the access based on identification information (ID and code number) (S50). For example, it is identified whether the user permission rating is higher than the second-rate.

When the user is allowed to use the word or CAD file based on the result of the identification, the database manager 160 allows the user terminal to read the corresponding word or CAD file or transfers the corresponding word or CAD file to the user terminal (S51). In contrast, when the user's usage of the word or CAD file is restricted, the database manager 160 based on the result of the identification, the database manger 160 messages to the user terminal that the access to the corresponding file is restricted (S52).

The enterprise business management unit 103 stores data associated with various events on the on-going business in the database 110, in communication with the database manager 160. Especially, the database manager 160 the data associated with the various events in communication with attribute data of the corresponding business.

Meanwhile, the enterprise business management unit 103 messages storing of the word or CAD file, whenever the word or CAD file is generated and stored, to at least one user terminal via the messaging processor unit 106.

In other words, when storing the word or CAD file initially created after launching the project development business, the enterprise business management unit 103 transfers corresponding event contents to the messaging processor unit 106. Accordingly, the messaging processor unit 106 messages the contents of the transferred events (having the initial version of the word or CAD file stored therein) to the user terminal registered as messaging object of the corresponding business in advance (S53).

When storing the word or CAD file corrected (changed) during the business performance in the enterprise, the enterprise business management unit 103 generates changed contents of generated events and it transfers the generated event contents to the messaging processor unit 106. Accordingly, the messaging processor unit 106 messages the contents of the transferred events (having the corrected (changed) version of the word or CAD file stored therein) to the user terminal registered as messaging object of the corresponding business in advance (S54).

At the same time, the enterprise business management unit 103 stores information on the correction (change) history of the file and business progress report in the database 110, in communication with the database manager 160. In this instance, the database manager 160 connects the information on the correction (change) history of the file and the business progress report generated from the enterprise business management unit 103 to the corrected (changed) file having the up-counting version information. After that, the database manager 160 stores the data in the preset business storage region.

The messaging processor unit 106 may message an access path to the corresponding file to enable the user to read the registered and stored file or corrected (changed) and stored file in the terminal possessed by the user corresponding to the messaging object via a viewer.

The collaboration management unit 104 categorizes the products generated in ordering and order-receiving business based on goods as ordering/order-receiving objects. After that, the collaboration management unit 104 stores the categorized data in the database 110 and simultaneously stores a history for each ordering/order-receiving business and a progress report in the database 110.

In addition, the collaboration management unit 104 messages contents of events to a registered user of the ordering enterprise and order-receiving enterprise, when events are generated in the ordering/order-receiving business for the good as the object of the ordering/order-receiving. The collaboration management unit 104 may translate the products generated in the ordering/order-receiving business and a history and a progress report for each ordering/order-receiving business into multi-languages (Korean, English, Japanese and etc.) before providing them.

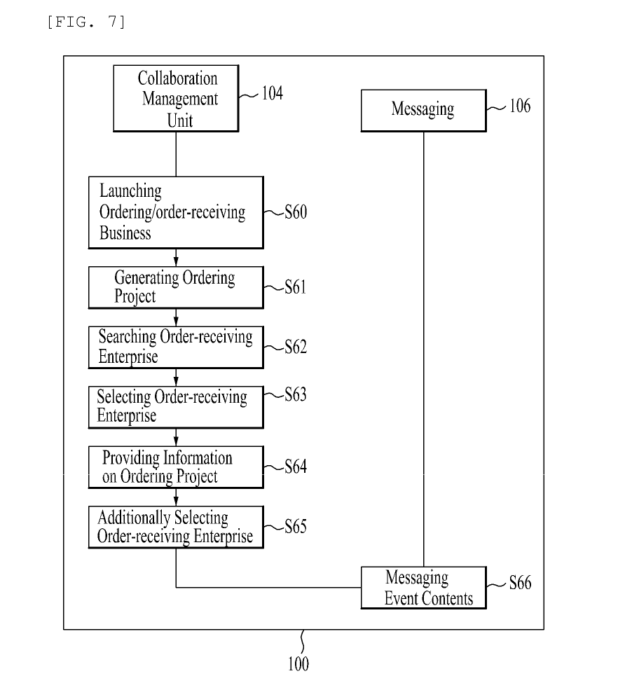

FIG. 7 is a diagram illustrating a collaboration process performed by a collaboration management unit according to the present invention. The collaboration process supports an ordering/order-receiving business between enterprises.

Referring to FIG. 7, when a specific ordering/order-receiving business is launched (S60); the collaboration management unit 104 gives usage permissions to users associated with an ordering enterprise and it generates an ordering project (S61).

The collaboration management unit 104 searches a plurality of order-receiving enterprises that can collaborate with each other based on ordering project information uploaded from the ordering enterprise (S62). After that, the collaboration management unit 104 selects one of order-receiving enterprises having an order-receivable condition for an ordered good (S63).

The collaboration management unit 104 provides the selected order-receiving enterprise with information associated with the ordering project (S64). Accordingly, the order-receiving enterprise selected for the ordering/order-receiving business progresses development business for the ordered good via the development business process (see, FIG. 4) and the change business process (see, FIG. 5) mentioned above.

When the ordering project information is changed because of design change of the ordering object good, the collaboration management unit 104 searches more collaborative order-receiving enterprises based on the changed information uploaded from the ordering enterprise and it selects an additional order-receiving enterprise having an order-receivable condition fitted to the changed contents of the ordering object (S65). Accordingly, the order-receiving enterprise additionally selected to the ordering/order-receiving business may progress development business for the ordering object good according to the development business process (see, FIG. 4) and the changed business (see, FIG. 5) described above.

When there is an order-receiving enterprise that withdraws from the corresponding ordering/order-receiving business, the collaboration management unit 104 searches more collaborative order-receiving enterprise based on the ordering project information uploaded from the ordering enterprise and selects an additional order-receiving enterprise having an order-receivable condition fitted to the ordering object good from the searched order-receiving enterprises (S65). Accordingly, the order-receiving enterprise additionally selected to the ordering/order-receiving business may progress the development business for the ordering object good via the development business process (see, FIG. 4) and the changed business process (see, FIG. 5) described above.

The collaboration management unit 104 may configurate data pool to the ordering enterprise of the ordering/ordering-receiving business and the order-receiving enterprise selected as a participant of the ordering/order-receiving business to share the data generated during the progress of the business. The collaboration management unit 104 may close the corresponding data pool at the time when the corresponding ordering/order-receiving business finishes. In other words, the collaboration management unit 104 configurates the data pool that is a dedicated network between the ordering enterprise and the order-receiving enterprise, once completed the selection of the order-receiving enterprise. Accordingly, the collaboration management unit 104 automatically gives usage permissions to have access to data associated with the ordering/order-receiving business and to read the data to a user terminal of the ordering enterprise and a user terminal of the order-receiving enterprise. Accordingly, the user terminal of the ordering enterprise and the user terminal of the order-receiving enterprise which are registered to the data pool may share processes of preparing, designing and correcting (changing) a project associated with the ordering/order-receiving business in real time.

Meanwhile, the collaboration management unit 104 messages a corresponding progress report associated with the project development progressed in the order-receiving enterprise to the user terminal of the ordering enterprise via the messaging processor unit 106, to monitor the progress report of the project development (S66). In other words, the collaboration management unit 104 messages contents of events generated by generation, storage and correction (change) of the file associated with ordering/order-receiving business in the development business process and the changed business processor to the user terminal registered as the messaging object of the ordering enterprise and the user terminal registered as the messaging object of the order-receiving enterprise.

In other words, whenever the data associated with the ordering/order-receiving business (a word or CAD file of a draft order, a corrected (changed) word or CAD file of a draft order) is registered and stored in the database 110 during the collaboration management unit 104 performing the development business progress for the ordering object good via the development business process (see, FIG. 4) and the changed business process (see, FIG. 5), the collaboration management unit 104 may message the storing to the user terminal registered as a messaging object of the ordering enterprise and the user terminal registered as a messaging object of the order-receiving enterprises, in communication with the database manager 160.

The user terminal registered as the messaging object of the ordering enterprise and the user terminal registered as the messaging object of the order-receiving enterprise may be given usage permissions to rear the data registered and stored in the database 110 associated with the corresponding ordering/order-receiving business. The user may rear the corresponding data via the viewer provided by the server 100, using the access path to the data messaged by the messaging processor unit 106.

The server 100 according to the present invention may register and store characteristic data for each enterprise or characteristic data for each user including a business field, a business place position (address) and a business or personal history for each enterprise or user in the database 110. The collaboration management unit 104 may search the registered and stored enterprise characteristic data or user characteristic data and search a plurality of order-receiving enterprises based on the searched data. For example, when the ordering enterprise searches for an appropriate order-receiving enterprise by inputting an automobile mold as key words, the collaboration management unit 104 proves enterprises associated with the automobile mold as the result of the searching.

The on-line meeting processor unit 105 provides an on-line meeting to registered enterprises and users in real time. The on-line meeting processor unit 105 supports data transfer to share data such as design drawings or documents during the on-line meeting. The on-line meeting processor unit 105 provides multipoint communication functions to enable multipoint exchange communication.

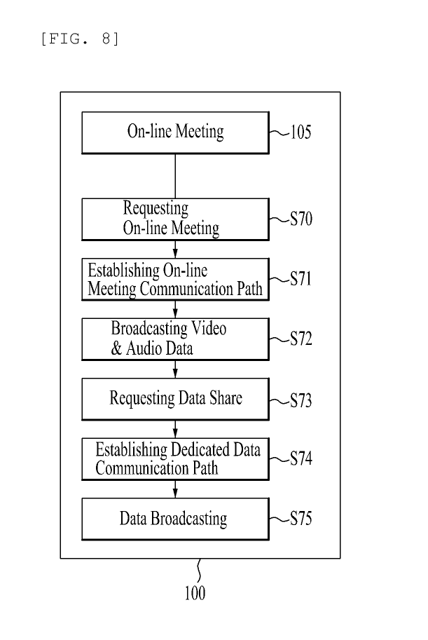

FIG. 8 is a diagram illustrating an on-line meeting performed by an on-line meeting processing unit according to the present invention.

Referring to FIG. 8, as a multipoint on-line meeting is requested (S70), the on-line meeting processor unit 105 establishes communication path for an on-line meeting among user terminals designated as participants of the on-line meeting (S71). For example, the on-line meeting processor unit 105 acquires information on the subject and participants of the on-line meeting from specified user terminals and forms a group of the corresponding on-line meeting based on the acquired information. After that, the on-line meeting processor unit 105 establishes a communication path among user terminals that belong to the on-line meeting group.

After the communication path is established, the on-line meeting processor unit 105 broadcasts video data and audio data transmitted among the user terminals that participate in the on-line meeting (S72).

When receiving a reading request for specific data stored in the database 110 from a specific user terminal during the one-line meeting, the on-line meeting processor unit 105 provides the requested data stored in the database 110 to the user terminal via the viewer. Accordingly, the participants of the on-line meeting can see the other participants of the on-line meeting on the other side and see the requested data.

When there is a request for data including design drawings and documents from the user terminals during the real time on-line meeting (S73), the on-line processor unit 105 establishes an additional dedicated data communication path (S74).

After establishing the data communication path, the on-line processor unit 105 broadcasts the data transmitted among the terminals of the user that participate the on-line meeting (S75). In other words, the on-line meeting processor enables the users to share the data during the on-line meeting.

The on-line meeting processor unit 105 may designate only predetermined ones of the participants of the on-line meeting to read the requested data or it may designate data broadcasting objects to transmit the data only to predetermined ones of the participants. The on-line meeting processor unit 105 acquires information on the reading objects from the terminals of the users requesting data reading and information on the data broadcasting objects from the user terminals requesting data broadcasting, only to designate the appropriate reading object or data broadcasting objects

The on-line meeting processor unit 105 provides information on the pre-registered participants to the user terminals during the real time on-line meeting, such that the participants can identify mutual personal data.

As another example, the on-line meeting processor unit 105 automatically designates the user terminals of the ordering enterprise and the user terminals of the order-receiving enterprise registered in the data pool, as an on-line meeting group, in communication with the collaboration management unit 104. Accordingly, when one of the user terminals registered in the data pool requests an on-line meeting, the on-line meeting processor unit 105 automatically establishes a communication path for the on-line meeting among the user terminals registered in the data pool. Eventually, the user terminals registered in the data pool provides only a subject of the on-line meeting to the on-line meeting processor unit 105 and no information on the participants of the on-line meeting.

The messaging processor unit 106 messages the events generated in the project development management unit 101, the change management unit 102, the enterprise business management unit 103 and the collaboration management unit 104 to users given usage permissions, in communication with the units.

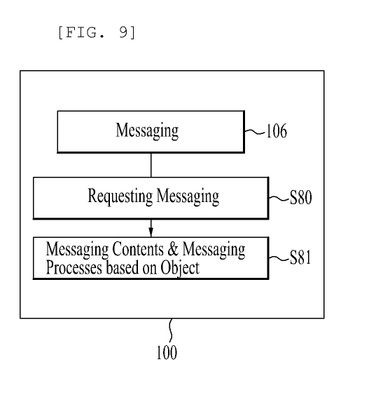

FIG. 9 is a diagram illustrating a messaging process performed by a message processing unit according to the present invention.

Referring to FIG. 9, when a specific message is requested by the project development management unit 101, the change management unit 102, the enterprise business management unit 103 and the collaboration management unit 104 (S80), the messaging processor unit 106 messages corresponding contents to user terminals registered as messaging objects. In this instance, the messaging processor unit 106 is provided with contents and objects of the message from the project development management unit 101, the change management unit 102, the enterprise business management unit 103 and the collaboration management unit 104. After that, the messaging processor unit 106 performs messaging processes based on the message contents and messaging objects (S81).

Specifically, the messaging processor unit 106 messages event facts to the user terminals registered as messaging objects in advance. Such event facts are generated while the development process of FIG. 4, the change business process of FIG. 5, the general business process of FIG. 6 and the collaboration process of FIG. 7 are progressed.

Also, the messaging processor unit 106 messages corresponding events as initial data or corrected (changed) data is registered and stored in the database 110, together with an access path of the corresponding data.

The database manager 160 associated with the processes for each unit performs version management for all of the data stored in the database 110. In this instance, the database manager 160 automatically generates version information of the files stored in the database 110 and it applies the version information to a name or attribute data of the corresponding file.

When automatically generating the version information, the generated category of the database manager 160 may include the date/time, the document number, a name of an enterprise/user and etc. for example, in case the date/time and the name of the enterprise are set in the generated category, the data/time is applied to the file name or the attribute information of the file whenever registered and stored in the database 110. In case the order-receiving enterprise registers and stores design drawings required in order-receiving application together with the date/time and the file name, the date/time and the name of the ordering enterprise are automatically applied to the file name or the file attribute information. In case the document number is set in the generation category, the document number counts up whenever the corresponding file is registered and stored in the database 110 and the up-counting document number is automatically applied to the file name or file attribute information.

The database manager 160 performs categorization processing for corrected (changed) contents possessed by all of the data stored in the database 110, associated with the process for each unit described above.

The database manager 160 categorizes the corrected (changed) contents, when the file registered and stored in the database 110 is corrected (changed).

For example, when components of the corresponding goods are A, B and C in the design drawing and only A is corrected (changed), the corresponding corrected (changed) file is set in A-category. Accordingly, it can be rapidly recognized which part of the file is corrected (changed) when checking the file stored in the database 110.

### Mode for Invention

When a particular feature, structure, or characteristic is described in connection with any embodiment, it is submitted that it is within the purview of one skilled in the art to affect such feature, structure, or characteristic in connection with other ones of the embodiments. Although embodiments have been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The collaboration system using the open public network according to the present invention may be interchangeably applied to the web-based collaboration infrastructure for collaboration between manufacturing enterprises, regardless of the business types, passing the limit of the manufacturing industry. Also, it may be applied to the expansion of the collaboration infrastructure to various products and business fields to induce participation of more enterprises.

1. A collaboration system using an open public network for providing collaboration services among a plurality of enterprises comprising:
a server configured to implement a plurality of processes for the collaboration services;
a user terminal connecting to the server via the open public network to restrictedly uses data generated by the processes according to a user permission; and
a database configured to store the data generated by the processes,
wherein the server implements the processes comprising a project development process, a data change process, a general business process and a collaboration process, and
the server restrictedly messages an event generated during the implementation of the processes to the user terminal according to the user permission.

2. The collaboration system using the open public network according to claim 1, wherein the server provides a data creating application to allow the user terminal to create data which will be stored in the database via the open public network, and
the server provides a viewer of the stored data to allow the user terminal to identify the data stored in the database via the open public network.

3. The collaboration system using the open public network according to claim 2, wherein the server sets a menu of the data creating application as available or unavailable according to the usage permission of the user terminal.

4. The collaboration system using the open public network according to claim 2, wherein the data stored in the database is a word or CAD file generated while implementing one or more of the project development process, the data change process, the general business process and the collaboration process.

5. The collaboration system using the open public network according to claim 2, wherein the data stored in the database is a word or CAD file corrected or changed while implementing one or more of the project development process, the data change process, the general business process and the collaboration process.

6. The collaboration system using the open public network according to claim 1, wherein the server restricts access to the data stored in the database and reading of the file in usage registration of the user terminal, and
the server gives the usage permission to restrict generation and change of data, which will be stored in the database, to the user terminal.

7. The collaboration system using the open public network according to claim 1, wherein the server messages an event generated while implementing the processes to the user terminal according to a usage permission.

8. The collaboration system using the open public network according to claim 1, wherein the server comprises,
a project development management unit configured to implement the project development process;
an enterprise business management unit configured to implement the general business process;
a collaboration management unit configured to implement the collaboration process; and
a database manager configured to control the database.

9. The collaboration system using the open public network according to claim 8, wherein the project development management unit gives the usage permission to the user terminal, when launching the project development process.

10. The collaboration system using the open public network according to claim 8, wherein the project development management unit stores data generated in the project development process and data changed in the project development process in the database, in communication with the database manager.

11. The collaboration system using the open public network according to claim 10, wherein the project development management unit messages an event for data generated in the project development process and data changed in the project development process to the user terminal according to the usage permission.

12. The collaboration system using the open public network according to claim 11, wherein the project development management unit further messages an access path to the data generated in the project development process and the data changed in the project development process to the user terminal.

13. The collaboration system using the open public network according to claim 10, wherein the database manager sets a storage region of the project in the database based on project information provided by the project development management unit, before storing the data generated in the project development process and the data changed in the project development process in the database.

14. The collaboration system using the open public network according to claim 13, wherein the database manager sets version information in the corresponding data, when storing the data generated in the project development process and the data changed in the project development process in the storage region of the project.

15. The collaboration system using the open public network according to claim 14, wherein the database manager counts up version information of the changed data, when storing the data changed in the project development process in the storage region of the project.

16. The collaboration system using the open public network according to claim 8, wherein the database manger messages usage permission to have access to corresponding data or restriction of access to corresponding data to the user terminal, there is usage access of the user terminal to the data stored in the database.

17. The collaboration system using the open public network according to claim 8, wherein the change management unit receives changed contents of data changed while the project development process is implemented from the project development management unit, and generates change history information.

18. The collaboration system using the open public network according to claim 17, wherein the change management unit stores in the generated change history information in the database in communication with the database manager, in a state of being connected with the changed data.

19. The collaboration system using the open public network according to claim 17, wherein the change management unit messages the generated change history information to the user terminal.

20. The collaboration system using the open public network according to claim 8, wherein the enterprise business management unit gives the usage permission to the user terminal, when launching the general business process.

21. The collaboration system using the open public network according to claim 8, wherein the enterprise business management unit stores data generated in the general business process and data changed in the general business process in the database, in communication with the database manager.

22. The collaboration system using the open public network according to claim 21, wherein the enterprise business management unit messages an event for data generation and change of the general business process to the user terminal according to the usage permission.

23. The collaboration system using the open public network according to claim 22, wherein the enterprise business management unit further messages an access path to the data generated in the general business process and the data changed in the general business process to the user terminal.

24. The collaboration system using the open public network according to claim 21, wherein the database manager sets a storage region of the general business in the database based on business information provided by the enterprise business management unit, before storing the data generated in the general business process and the data changed in the general business process in the database.

25. The collaboration system using the open public network according to claim 24, wherein the database manager sets version information in the corresponding data, when storing the data generated in the general business process and the data changed in the general business process in the storage region of the general business.

26. The collaboration system using the open public network according to claim 25, wherein the database manager counts up version information of the changed data, when storing the data changed in the general business process in the storage region of the general business.

27. The collaboration system using the open public network according to claim 8, wherein the collaboration management unit generates an ordering project based on information uploaded from a user terminal of an ordering enterprise out of the user terminals, when the collaboration process for ordering/order-receiving business is launched.

28. The collaboration system using the open public network according to claim 27, wherein the collaboration management unit searches collaborative enterprises based on the information on the ordering project, and selects an order-receiving enterprise having a set order-receivable condition out of the searched enterprises as an order-receiving enterprise of the ordering project.

29. The collaboration system using the open public network according to claim 28, wherein collaboration management unit additionally searches collaborative enterprises based on changed information on the ordering project and additionally selects an order-receiving enterprise having a set order-receivable condition out of the additionally searched enterprises as an order-receiving enterprise of the ordering project, as changed information is uploaded from a user terminal of the ordering enterprise after the ordering project is changed.

30. The collaboration system using the open public network according to claim 28, wherein the collaboration management unit additionally searches collaborative enterprises based on the information on the ordering project, as at least one of the order-receiving enterprises withdraws, and additionally selects an order-receiving enterprise having a set order-receivable condition.

31. The collaboration system using the open public network according to claim 28, wherein collaboration management unit configurates a data pool corresponding to a dedicated network for a user terminal of the ordering enterprise and a user terminal of the order-receiving enterprise to share data generated during the progress of the collaboration process between the user terminal of the ordering enterprise and the user terminal of the order-receiving enterprise.

32. The collaboration system using the open public network according to claim 28, wherein the collaboration management unit messages a progress report to the user terminal of the ordering enterprise, as the project development process is implemented by the project development management unit after a user terminal of the order-receiving enterprise connects to the server.

33. The collaboration system using the open public network according to claim 1, wherein the server further implements an on-line meeting process among user terminals for the collaboration service and a messaging process for messaging the event.

34. The collaboration system using the open public network according to claim 33, wherein the server further comprises,
an on-line processor unit configured to implement the on-line meeting process; and
a messaging processor unit configured to implement the messaging process.

35. The collaboration system using the open public network according to claim 34, wherein the on-line meeting processor unit establishes a communication path for an on-line meeting among user terminals designated as on-line meeting participants out of the user terminals in the on-line meeting process and a dedicated communication path for data transmission.

36. The collaboration system using the open public network according to claim 34, wherein the messaging processor unit messages corresponding contents to a user terminal registered as a messaging object out of the user terminals, when there is a messaging request during the implementation of the project development process, the data change process, the general business process and the collaboration process.
